(19) United States
(12) Patent Application Publication
(10) Pub. No.: US 2008/0105527 A1
(43) Pub. Date: May 8, 2008

(54) Switches and Devices for Integrated Soft Component Systems

(76) Inventor: Steven Andrew Leftly, Skipton (GB)

Correspondence Address: BROMBERG & SUNSTEIN LLP, 125 SUMMER STREET, BOSTON, MA, 02110-1618, US

(21) Appl. No.: 11/663,053

(22) PCT Filed: Sep. 16, 2005
(86) PCT No.: PCT/GB05/03582

§ 371 Date: Nov. 2, 2007

(30) Foreign Application Priority Data
Sep. 16, 2004 (GB) 0420683.5
Sep. 22, 2004 (GB) 0420997.9
Jan. 7, 2005 (GB) 0500276.1

(51) Int. Cl. H01H 13/14

(52) U.S. Cl. 200/530

(57) ABSTRACT

Switches and devices suitable for use in soft articles such as textiles are provided, which can be used to create integrated soft component systems. According to one embodiment, a conductor carrier (2) containing two parallel electrically conductive tracks (1) is disposed adjacent to a flexible contact maker (4). The flexible contact maker (4) comprises an electrically conductive substrate. One of the electrically conductive tracks of the conductor carrier (2) is permanently attached to the flexible contact maker (4) at a contact point (6). The other electrically conductive track has a contact point (3). In an open configuration, the flexible contact maker (4) does not make electrical contact with the contact point (3). In a closed configuration, the contact maker does make contact with the contact point (3) and closes the circuit between the two electrically conductive tracks. The flexible contact maker may be resiliently biased in either or both of the open and closed configurations.

This invention relates to the use of switches and devices such as sensors in applications where flexibility and low profile are required. In particular, it relates to the use of switches and devices in integrated soft component systems.

Current low profile switch technology utilises hard or semi-rigid printed circuit boards (PCBS) and wires or cables. For example, electronic keypads and switches already exist whereby a conductive rubber contact making actuator is fixed on top of a large hard PCB as part of a non-flexible electronics product. These types of switch and sensor systems have limited use in soft, textile or flexible environments that often require high durability to mechanical forces such as bending and/or stretching. Conventional low profile switch technology is also not durable for repeated exposure to wet environments (such as laundering and dry cleaning) and/or environments where mechanical forces are repeatedly exerted on the devices. Switching systems using layers of fabrics are also not suitable as they cannot be manufactured economically or be of sufficient durability and reliability. These fabric technologies tend to rely on many-layered fabrics which are difficult to manufacture.

An example of a conventional switching system using layers of fabric can be found in PCT patent application no. WO 01/75778. This document discloses a pressure sensitive textile in which conductive fibres and insulative fibres are interspersed in each of the warp yarn and weft yarn of the textile. By means of weave structures such as floated yarns and composite conductive/insulative yarns, the conductive fibres in the warp and weft yarns can be kept apart at their crossover points, with the conductive fibres being forced into contact only when the textile is compressed.

However, such a conventional textile has disadvantages in that it is difficult, and so relatively expensive, to manufacture the fibre layers, and in that some accidental (unwanted) contacts between the conductive fibres cannot be avoided, as only a small force is required to push the conductive fibres together. The separation of the conductive fibres deteriorates with use, such as being repeatedly exposed to wet environments or being repeatedly subjected to mechanical forces. Thus, it is difficult to manufacture such a textile economically and to ensure that the switching mechanisms in the textile are sufficiently durable and reliable.

Many previously considered textiles incorporate conductive elements into a uniform weave structure which then dictates where electrical connections can be made—i.e. where the conductive elements can be made to contact each other. In such cases the type, and location of the connection is fixed at the time of weaving, which limits the usefulness of the textile.

It is therefore desirable to provide switches for use within a soft or textile material which are reliable and durable, and which can be manufactured economically.

Furthermore, electronic circuits are known that use hard or semi-flexible PCBs that generally contain an array of small electronic components that perform a variety of electronic functions within the circuit. Some of these components are so small in size that they can be placed invisibly within the structure of a soft or flexible substrate.

It is desirable to allow for the production of large volumes of an economical soft/flexible keypad, switch system, sensor system or other electronic component system using flexible materials to create a soft circuit to replace the conventionally used hard PCB elements within a contact switch or sensor circuit. Furthermore, it is desirable that using this soft circuit a range of electronic components can be attached and/or embedded within a specially designed flexible structure. Thus, it is desirable to provide a system where different electronic components are fully integrated into a soft and flexible substrate, and where the substrate acts as part of the electronic circuit so that the whole system has soft and flexible properties.

According to a first aspect of the present invention, there is provided a switch for use in a soft article, such as a textile article, the switch comprising:

a conductor carrier having a plurality of electrical conductors; and

a flexible contact maker comprising an electrically conductive substrate, the flexible contact maker being disposed adjacent to the conductor carrier; wherein

the contact maker is configurable in either a first configuration in which it electrically connects two of the electrical conductors or a second configuration in which it does not electrically connect two of the electrical conductors, the contact maker being resiliently biased in at least one of the first and second configurations.

The flexible contact maker may comprise a flexible material, preferably an electrically conductive grade silicone or electrically conductive rubber moulded or extruded in a generally flat, preformed shape so as to form an electrically conductive sheet.

The conductor carrier is preferably a flexible preformed structure containing a number of separate electrical conductors. These may be in the form of electrically conductive tracks, for example. Preferably, the electrical conductors are generally shielded within the conductor carrier but become exposed at specific designated positions (contact points) along the conductor carrier so as to correspond with specific designated positions on the contact maker.

The flexible contact maker is placed over (i.e. adjacent to and facing) the conductor carrier and is preferably mechanically deformable so that when sufficient force is exerted on it the contact maker is caused to assume either the first or second configuration. In the first configuration, the circuit between the contact maker and the electrical conductors within the conductor carrier may be closed by one of the following means:
a) whilst the contact maker is already permanently fixed to one contact point on one electrical conductor, a force exerted on the contact maker causes it to make contact with another contact point on another electrode (the contact maker may be permanently fixed to the contact point by sewing, conductive adhesive, a crimping fixture or other textile fixture);
b) a force is exerted on the contact maker causing it to make contact with two contact points, on different electrical conductors, simultaneously.

When the circuit is closed the electrical resistance between the electrical conductors decreases.

In the second configuration of the contact maker, circuit closure may be prevented by:
a) a layer of microdots (nodules) of non-conductive moulded or printed polymer material deposited on the lower surface of the contact maker so as to prevent contact with the contact points of the electrical conductors;
b) one or more flexible domes or concave recesses moulded within the contact maker so as to give a fixed shape at the contact points and prevent circuit closure; these domes or recesses may also provide a haptic and tactile feedback mechanism during circuit closure;
c) moulding the contact maker with a series of depressions or domes (recesses) that will hold the contact maker off the conductor carrier at the contact points;
c) a flexible material with holes placed below the contact maker to prevent contact in the second configuration, but to allow contact when force is exerted, causing the contact maker to be in the first configuration;
d) a layer of switch domes bonded on top of or underneath the contact maker that correspond with the contact points to provide tactile/haptic feedback or a sound when a switch is pressed;
e) a combination of a) and either b) or c).

Other layers may be bonded above the contact maker and/or below the conductor carrier. These layers may be of a textile, gel, foam, film, polymer or other soft/flexible material to give the switch specific properties such as tactility, protection from abrasion/wear and/or to make it suitable for sewing. The contact maker and conductor carrier may also be encapsulated in a polymer material using compression, injection or other moulding techniques to create a flexible contained device that may also be waterproof or resistant to moisture or chemicals or other harsh environments.

The conductor carrier and electrical conductors may be constructed from the following:
a) flexible flat cable (FFC) containing metallic foil strips laminated with polymer shielding in a flat strip film;
b) textile fabric containing metallic fibre conductors woven, knitted, braided or laid in the structure;
c) textile fabric containing wires woven, knitted or laid in the structure;
d) flexible film or fabric with printed or coated electrically conductive tracks;
e) a flexible printed circuit on a polymeric film (FPC);
f) any combination of the above.

The conductor carrier may contain any number of electrical conductors, such as electrically conductive tracks, within the above structure. The electrical conductors may be aligned to correspond with an industry standard termination method and are usually spaced at 2.54 mm or 1.25 mm apart.

The electrically conductive substrate of the contact maker may be constructed using the following methods:
a) moulded electrically conductive rubber panels manufactured using injection or compression or other moulding techniques.
b) moulded electrically conductive rubber bonded onto flexible materials (such as textile materials or flexible films).
c) electrically conductive rubber coated onto a flexible material.
d) electrically conductive rubber bonded to non-conductive rubber in sheet form.

If moulded, the contact maker may have integral shapes formed within the structure such as domes, recesses, rubber dots or nodules and/or hollow regions, so as to prevent contact with the electrical conductors in the first configuration.

The contact points of the electrical conductors can be constructed using the following methods:
a) a metallic contact component (fixture) that is attached to the conductor carrier at specific locations using a tool (such as a crimp termination component e.g. Nicomatic Crimplex crimp contacts);
b) a metallic wire or yarn exposed from the shielded section of the conductor carrier (such as Du Pont—Aracon or Silver coated nylon yarn); at the contact point this wire or yarn may be raised at the surface of the structure to allow electrical contact;
c) an electrically conductive material printed or coated on the conductor carrier;
d) an electrically conductive adhesive material placed on the conductor carrier surface;
e) a metallic fixture used in the textile industry, such as a button, rivet or snap fastener.

The contact maker may be fixed to the conductor carrier using one of the following methods:
a) the contact maker may be sewn onto the conductor carrier;
b) the contact maker may be bonded or glued onto the conductor carrier;
c) the contact maker may be fixed onto the conductor carrier using hard attachment methods such as rivets, snaps, studs, zips or other commonly used textile fixtures;
d) the contact maker may be fixed onto the conductor carrier using a crimp component.

The switch may be encapsulated using any or all of the following methods:
a) the switch may be bonded between further layers of fabrics or flexible films;
b) the switch may be placed into an injection tool during the moulding process and become part of an injection moulded article;
c) the switch may be coated with a gel, polymer or polymer foam material to provide certain tactile or other properties;
d) the switch may be attached to another piece of fabric using adhesive seam tapes commonly used in the garment construction industry;
e) the switch may be attached to another fabric article using a removable system such as Velcro.

The switch may be connected to further electronics using several methods:
a) attaching crimp contacts to the ends of the electrical conductors using a tool (such as those used in the FFC/Flexible printed circuit industry); these crimp contacts may then be connected to a mating connector or soldered onto a PCB or connector;
b) attaching textile based connectors to the ends of the electrical conductors such as snaps, rivets or other textile fixtures;
c) soldering wires directly onto the electrical conductors;
d) attaching the electrical conductors to a secondary conductor carrier by way of sewing adhesives or other fastening system.

Thus, according to the first aspect of the invention, a switch may be provided which is suitable for use in a textile article. Advantageously, such a switch is durable and reliable, even when subjected to repeated mechanical forces on the contact maker and to wet environments. Furthermore, such a switch may be a multiple switch and may be connected to other electronic components.

According to a second aspect of the invention, there is provided a device for use in a soft article, such as a textile article, the device comprising:

a conductor carrier having a plurality of electrical conductors;

at least one contact maker mounted on the conductor carrier and physically attached to two of the electrical conductors; and

an outer layer covering the conductor carrier and the at least one contact maker; wherein

each contact maker is configurable to provide an electrical connection between the two electrical conductors to which it is physically attached, the electrical connection depending on a force exerted on the outer layer above the contact maker.

Each contact maker may be an electronic component such as an SMD tact switch or a light sensitive component.

As in the first aspect, the conductor carrier is preferably a flexible preformed structure containing a number of separate electrical conductors, such as electrically conductive tracks. The electrical conductors are preferably flexible electrically conductive materials that are generally shielded within the conductor carrier but may become exposed at specific designated positions (contact points) along the conductor carrier so as to correspond with specific designated positions for the attachment of the contact makers. The conductor carrier acts like a databus supplying current to and from the contact points and hence the contact makers.

The conductor carrier and electrical conductors may be constructed in the same way as in the first aspect.

The conductor carrier may contain any number of conductor carriers within the above structure. The conductor carriers preferably are aligned to correspond with an industry standard termination method and are usually spaced at 2.54 mm or 1.25 mm apart.

The contact points of the device can be constructed in the same way as in the first aspect of the invention.

The contact makers may be attached to the contact points using the following methods:
a) the contact makers may be soldered directly onto a contact point fixture or material;
b) the contact makers may be attached using electrically conductive Epoxy, or other conductive adhesive material, directly onto a contact point fixture or material;
c) the contact makers may include a small PCB which is in turn soldered directly onto a contact point fixture or material; this allows for easy positioning and soldering or fixing of a very small contact maker;
d) the contact makers may include a small PCB which is in turn attached using electrically conductive Epoxy, or other conductive adhesive material, directly onto a contact point fixture or material;

Other layers may be bonded above the contact makers and/or below the conductor carrier. These layers may be of a textile, gel, foam, film, polymer or other soft/flexible material to give the device specific properties such as tactility, protection from abrasion/wear and/or to make it suitable for sewing. The contact makers and conductor carrier may also be encapsulated in a polymer material using compression, injection or other moulding techniques to create a flexible contained device that may also be waterproof or resistant to moisture or chemicals or other harsh environments. The outer layer may have a design printed, moulded or laid in its structure so as to indicate the location of a switch or sensing area to a user.

The contact makers used in the device are preferably surface mount devices (SMD) as these are very small and can be placed on the conductor carrier using “pick and place” machinery or by hand. The types of SMD electronic components useful in the device are: switches, tact switches, light dependent resistors, photodiodes, phototransistors, light emitting diodes, thermistors, pressure sensing SMDs, moisture sensors and other components of this type.

The device may be encapsulated using the same methods as may be used in the first aspect.

The device can be connected to further electronics using the same methods as in the first aspect.

In accordance with the aspects of the invention, switches and devices can be easily produced that contain multiple switches, sensors or light emitting components using the latest in available electronic component technology. Advantageously, these components can be completely hidden within a soft, flexible structure (e.g. textile article) making them suitable for use in harsh environments. This in turn provides hidden intelligence and functionality to soft structures such as fabrics.

The switches and devices according to the first and second aspects of the invention have the following advantages over existing technologies:
the switches and devices embodied by the invention can be manufactured very economically because of the small number of simple parts;
since all these parts are flexible or soft in nature, or very small parts embedded within a soft structure, the switches and devices can be used as switches or sensors in a large number of applications for example but not limited to: wearable electronics, textile switches/ sensors, automotive seat switches or sensors, automotive interior switches or sensors, domestic interior switches or sensors, under floor switches or sensors, toy switches or sensors, medical switches or sensors, electronic components within garments, switches or sensors positioned on the human body;
the conductor carrier can be manufactured using continuous processes such as weaving, and therefore can be economically produced in large volume;
single or multiple switches or sensors or other switch devices can be made from the same components;
all the electrical conductors used in the switches and devices are prelaid within a single structure and are therefore easy to terminate and connect to whilst providing the minimal amount of further connections that might be prone to failure;
the contact maker of the first aspect can be manufactured in a continuous process using moulding, such that it can be economically produced in large volume.

Reference will now be made, by way of example only, to the accompanying drawings, in which:

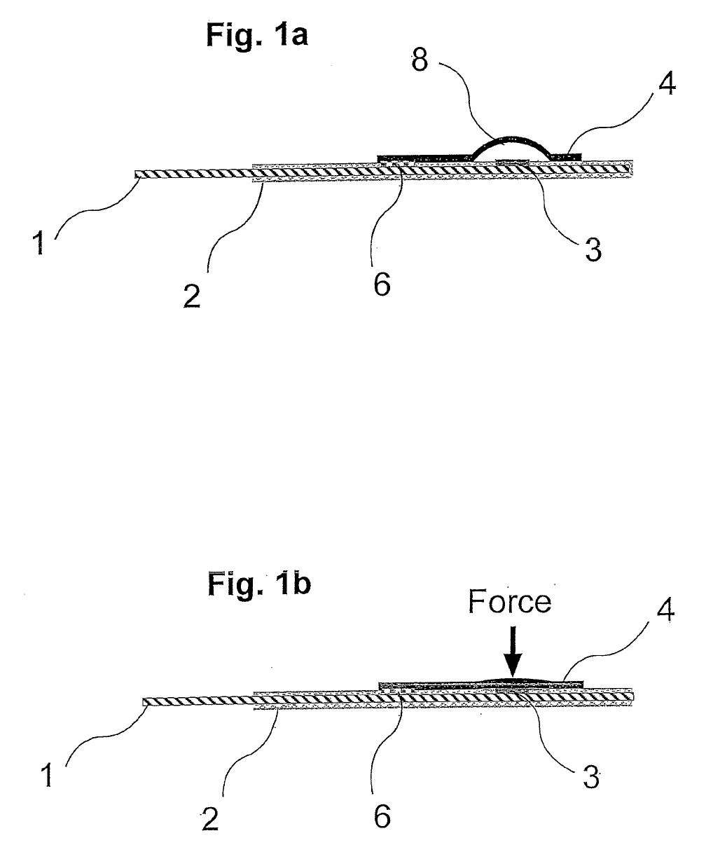

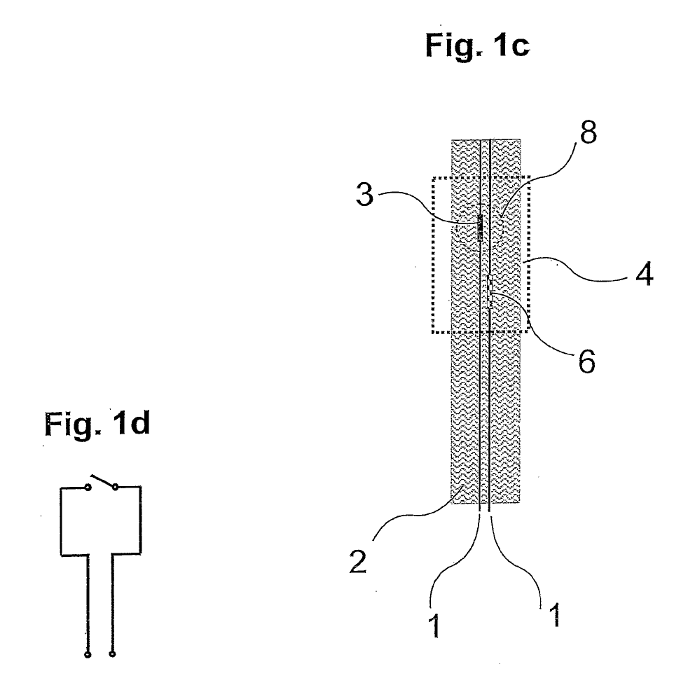

FIG. 1a shows a side cross-section of a first embodiment of a switch, wherein the switch is in an open (second) configuration;

FIG. 1b shows a side cross-section of the switch of FIG. 1a, wherein the switch is in a closed (first) configuration;

FIG. 1c is a top view of the switch of FIGS. 1a and 1b;

FIG. 1d is a circuit diagram representing the circuit formed by the switch of FIGS. 1a and 1b;

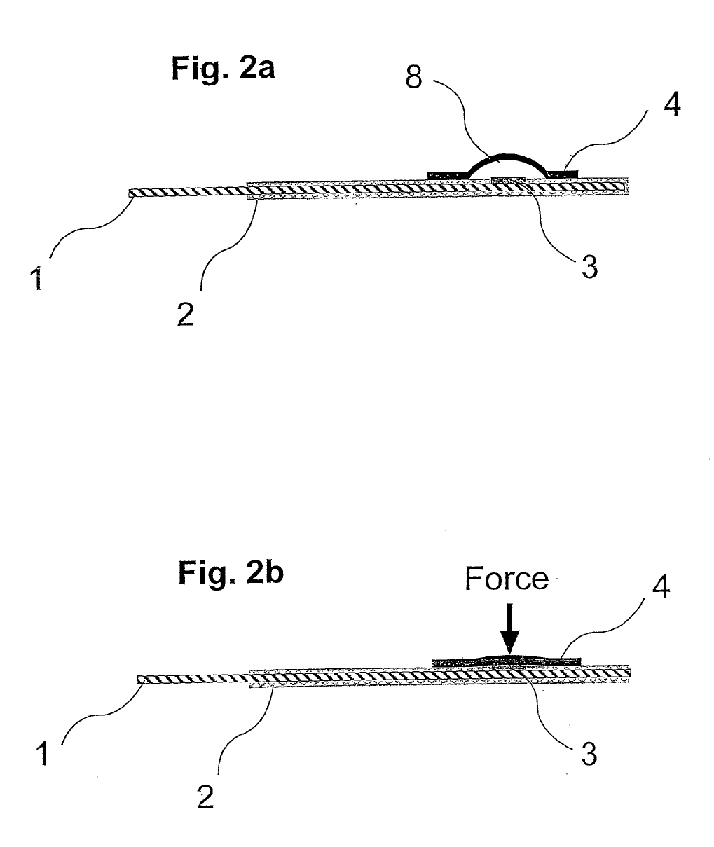

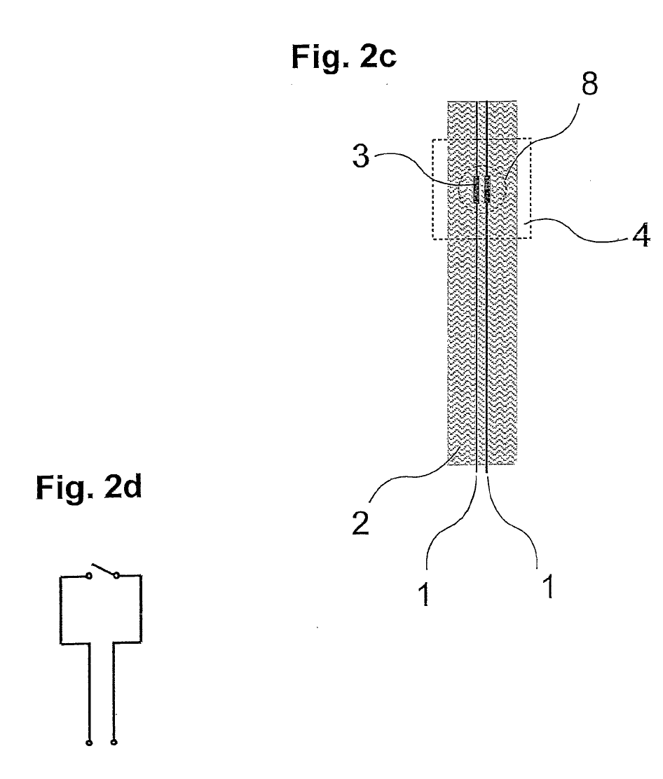

FIG. 2a shows a side cross-section of a second embodiment of a switch, wherein the switch is in a second configuration;

FIG. 2b shows a side cross-section of the switch of FIG. 2a, wherein the switch is in a first configuration;

FIG. 2c is a top view of the switch of FIGS. 2a and 2b;

FIG. 2d is a circuit diagram representing the circuit formed by the switch of FIGS. 2a and 2b;

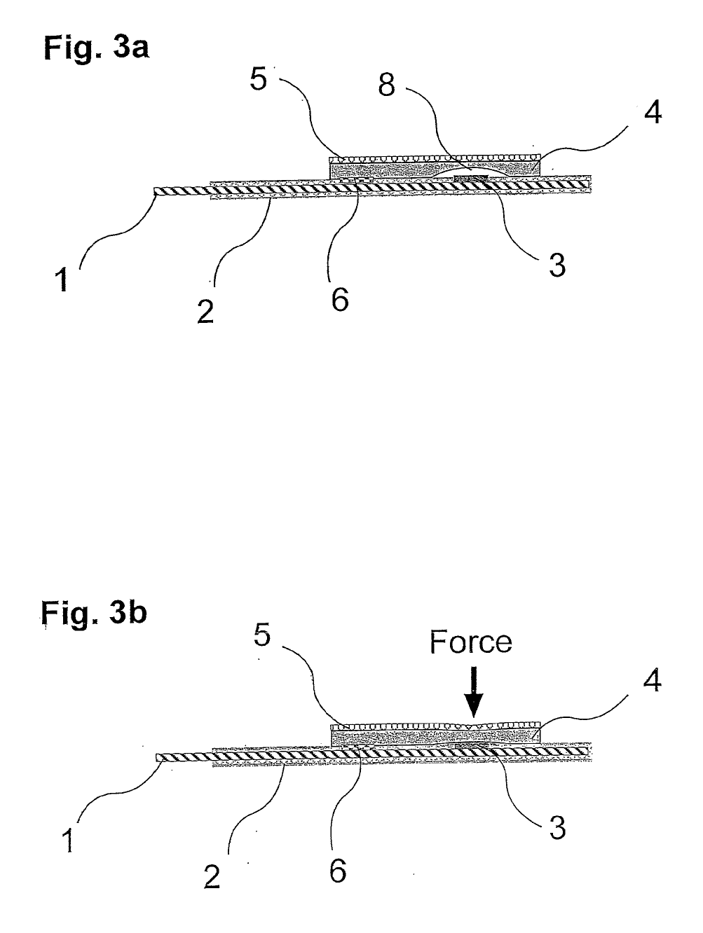

FIG. 3a shows a side cross-section of a third embodiment of a switch, wherein the switch is in a second configuration;

FIG. 3b shows a side cross-section of the switch of FIG. 3a, wherein the switch is in a first configuration;

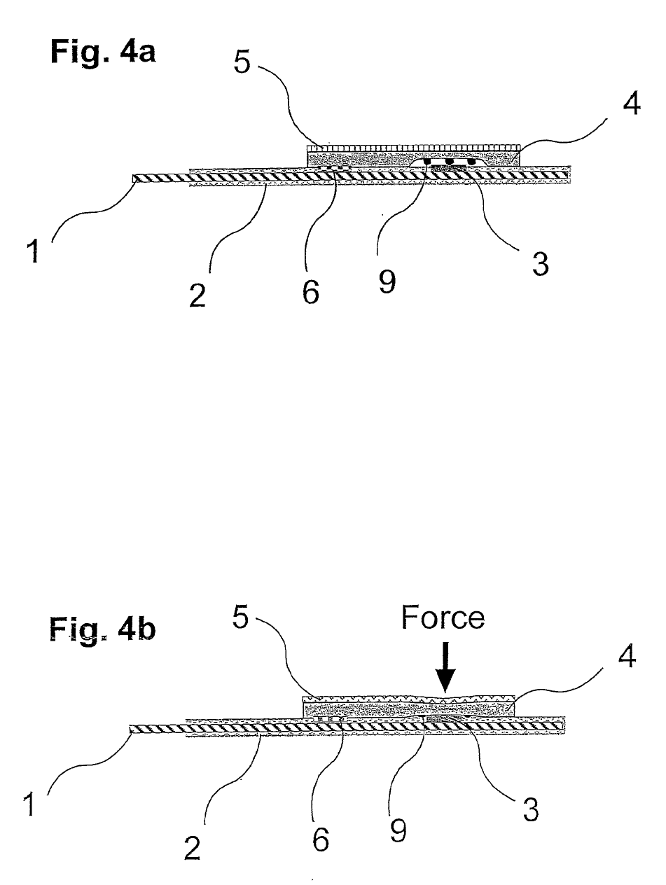

FIG. 4a shows a side cross-section of a fourth embodiment of a switch, wherein the switch is in a second configuration;

FIG. 4b shows a side cross-section of the switch of FIG. 4a, wherein the switch is in a first configuration;

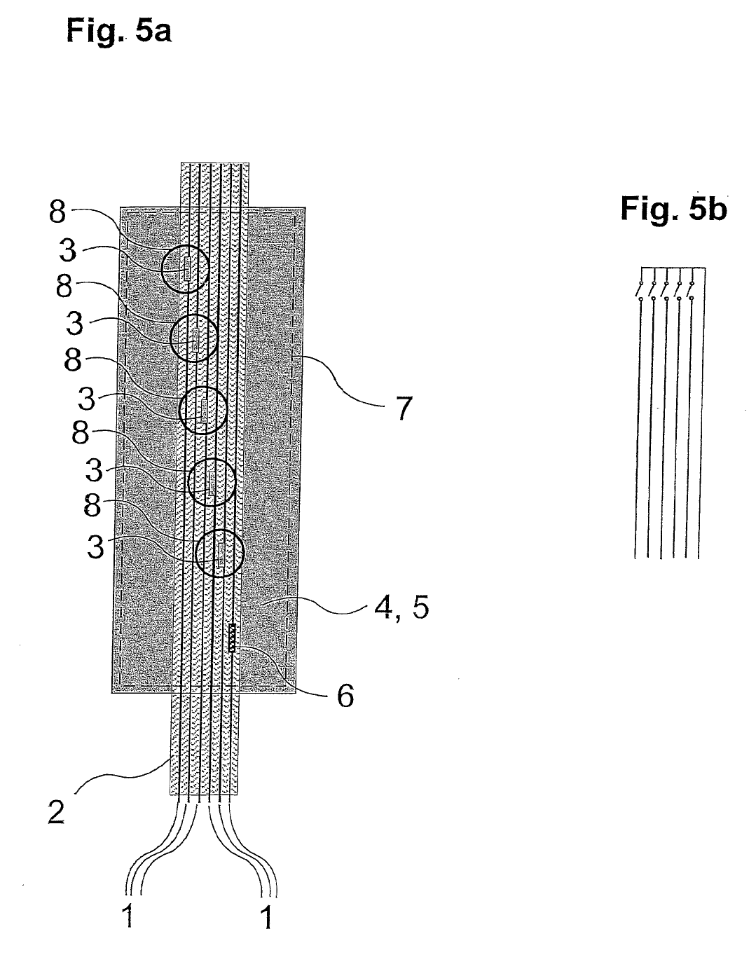

FIG. 5a is a top view of a fifth embodiment of a switch;

FIG. 5b is a circuit diagram representing the circuit formed by the switch of FIG. 5a;

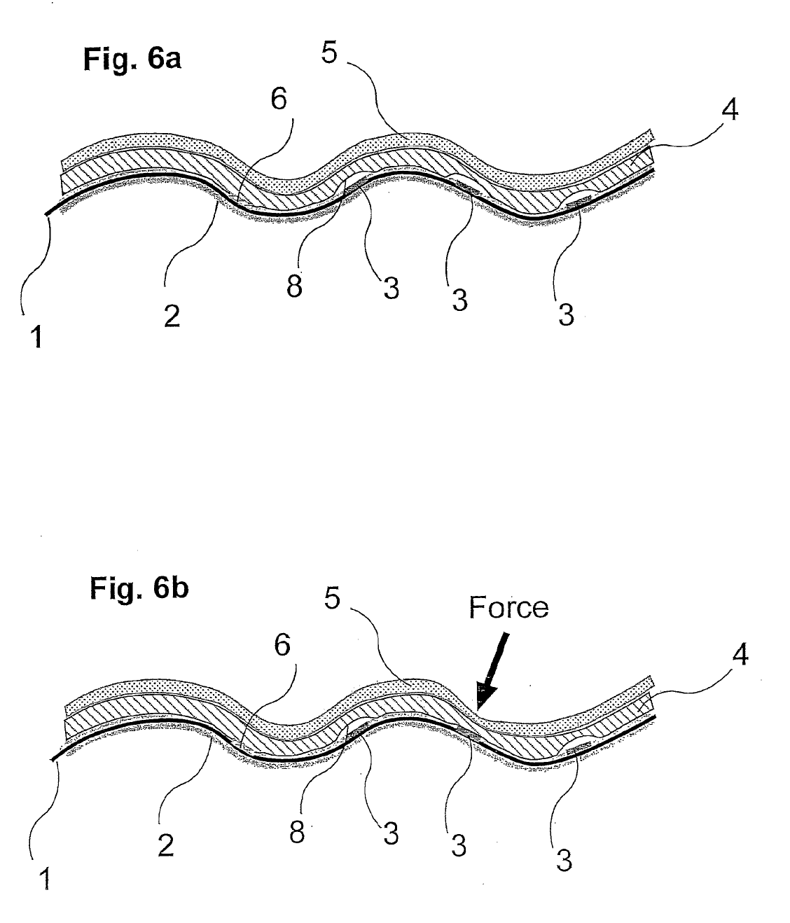

FIG. 6a is a side cross-section of a switch according to a sixth embodiment, wherein the switch is in a second configuration;

FIG. 6b is a side cross-section of the switch of FIG. 6a, wherein the switch is in a first configuration;

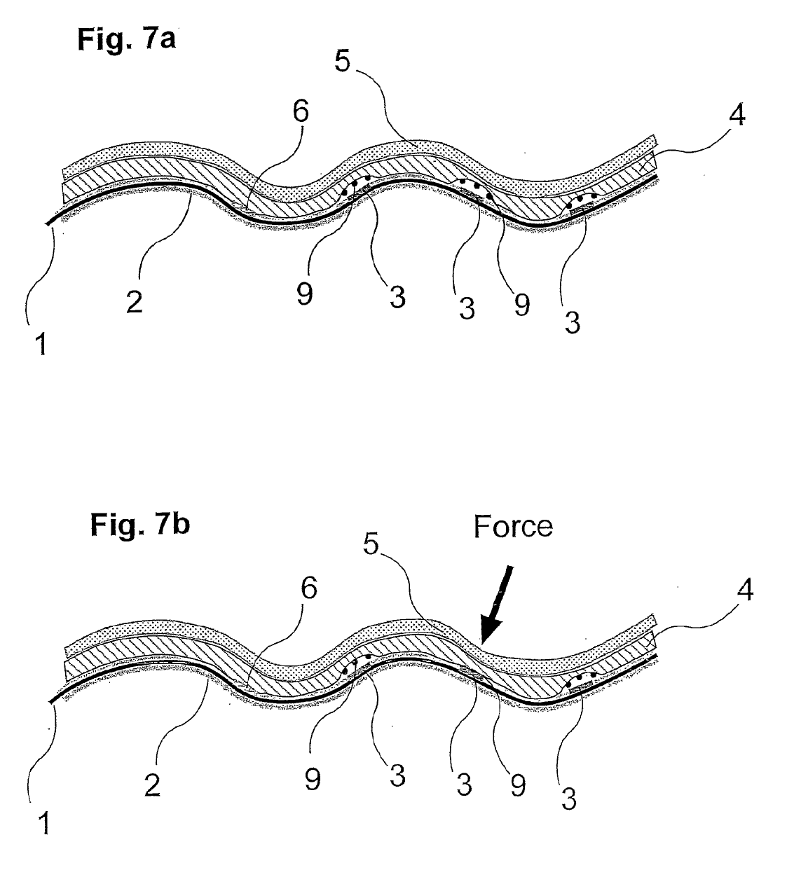

FIG. 7a is a side cross-section of a switch according to a seventh embodiment, wherein the switch is in a second configuration;

FIG. 7b is a side cross-section of the switch of FIG. 7a, wherein the switch is in a first configuration;

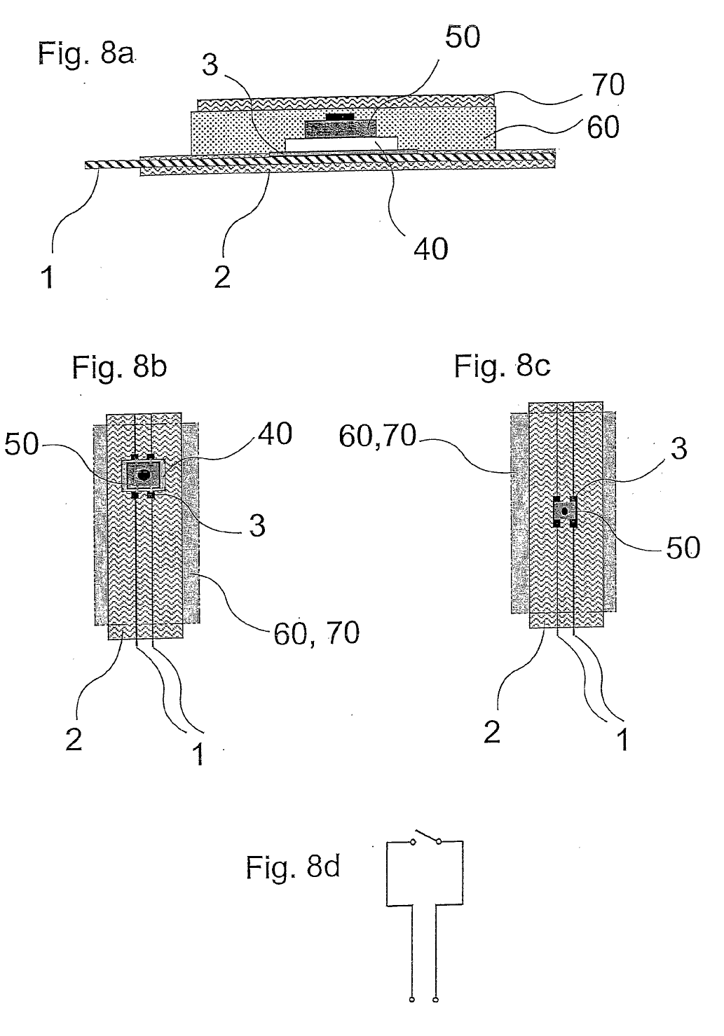

FIG. 8a is a side cross-section of a device according to an eighth embodiment;

FIG. 8b is a top view of the device of FIG. 8a;

FIG. 8c is a top view of a similar device to that of FIG. 8a;

FIG. 8d is a circuit diagram representing the circuit formed by the device of FIGS. 8a and 8c;

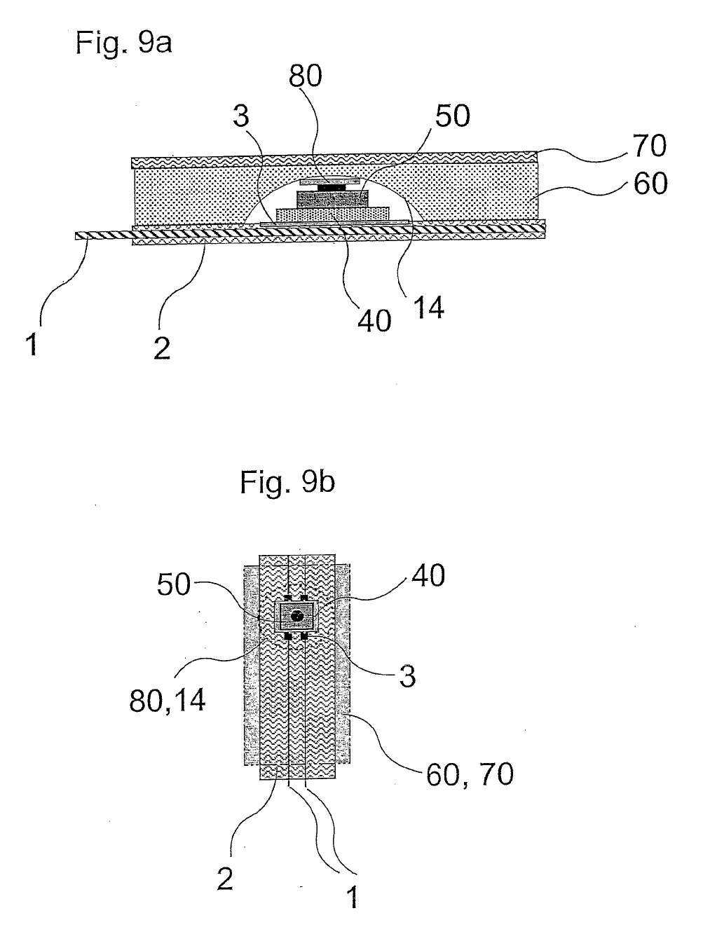

FIG. 9a is a side cross-section of a device according to a ninth embodiment;

FIG. 9b is a top view of the device of FIG. 9a;

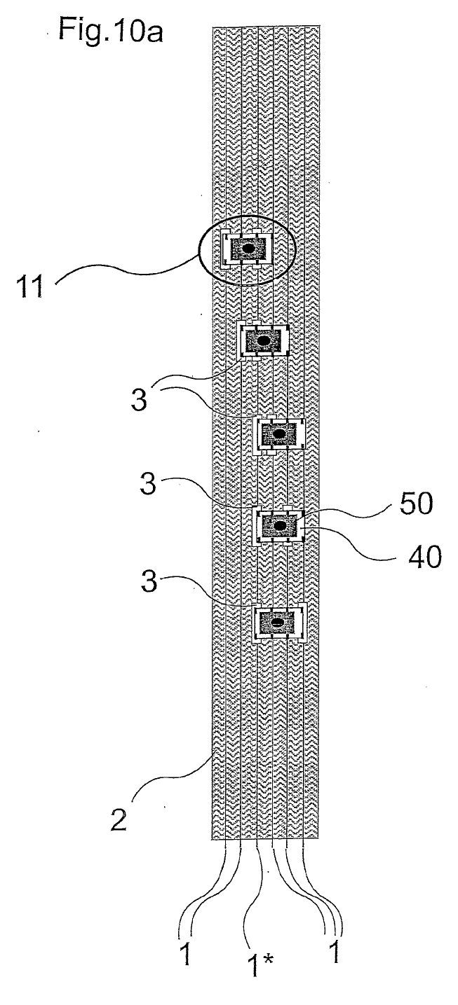

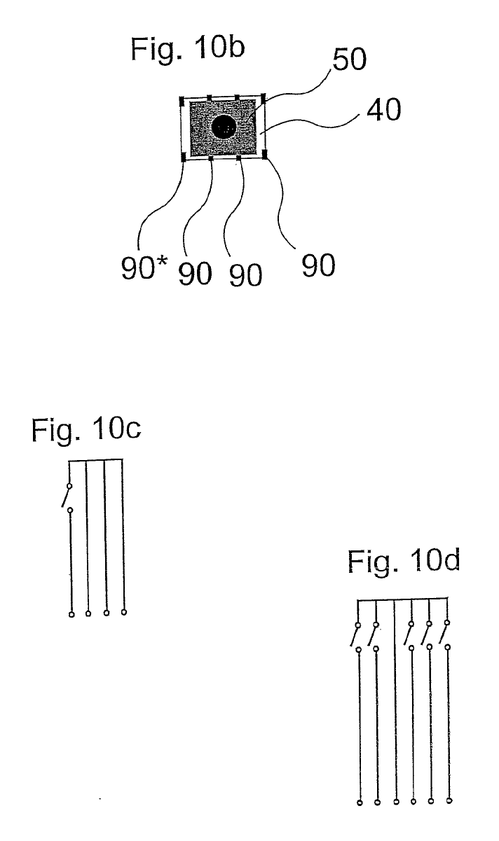

FIG. 10a is a top view of a device according to a tenth embodiment;

FIG. 10b is an exploded view of switch assembly 11 of FIG. 10a;

FIG. 10c is a circuit diagram representing switch assembly 11;

FIG. 10d is a circuit diagram representing the device of FIG. 10a;

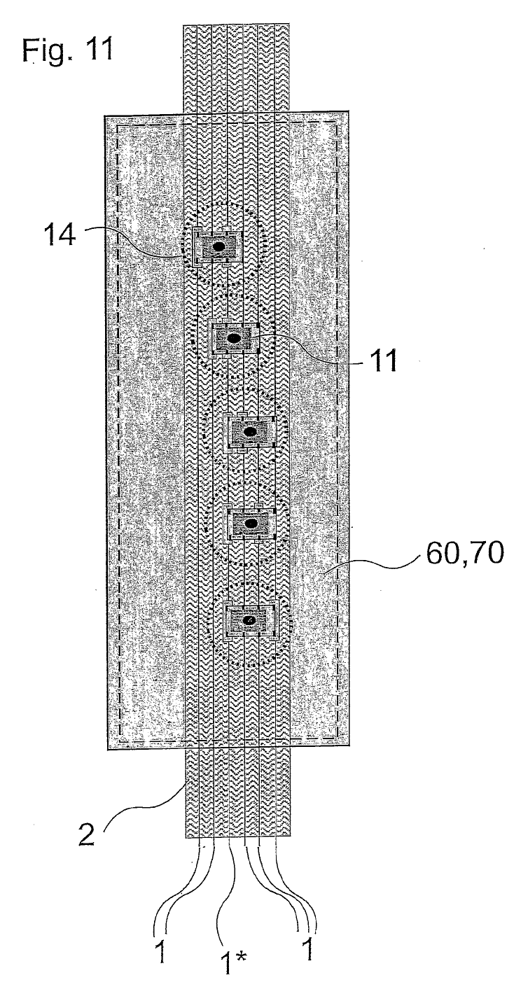

FIG. 11 is a top view of a device according to the tenth embodiment but showing a fabric cover system;

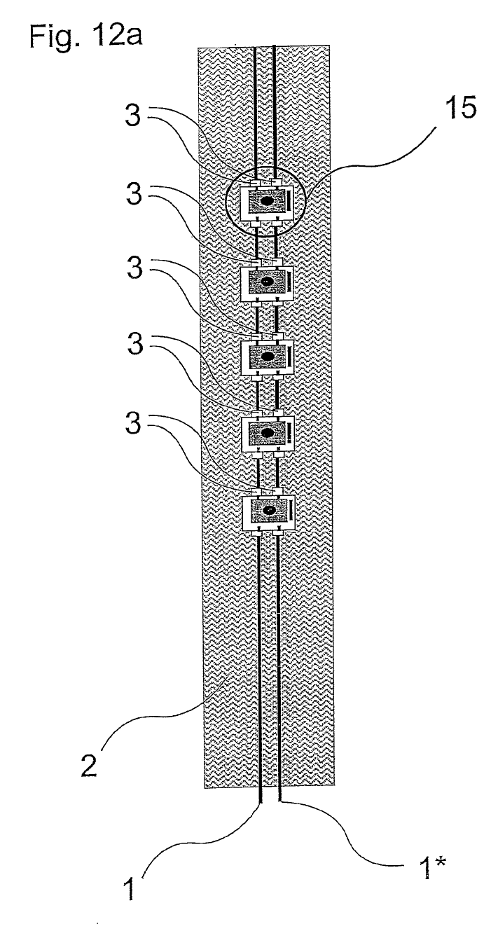

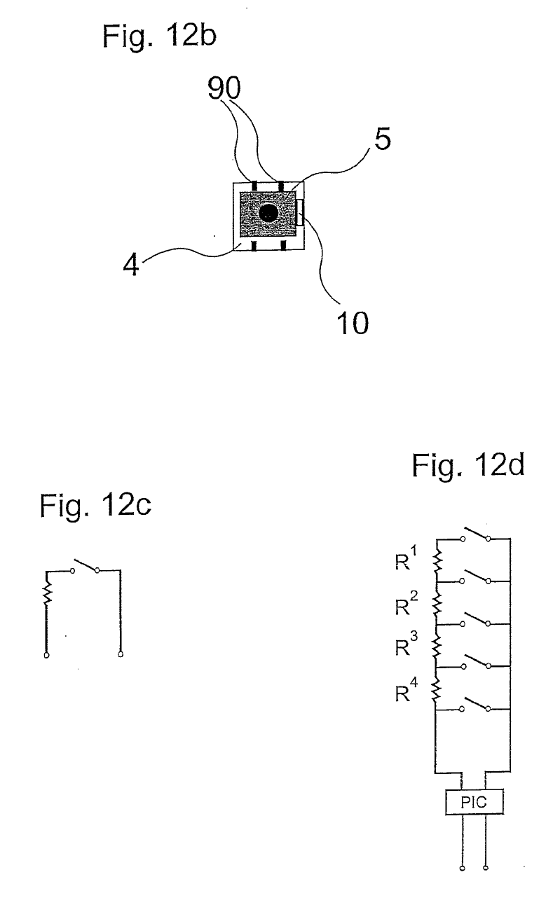

FIG. 12a is a top view of a device according to an eleventh embodiment;

FIG. 12b is an exploded view of switch assembly 15 of FIG. 12a;

FIG. 12c is a circuit diagram representing switch assembly 15;

FIG. 12d is a circuit diagram representing the device of FIG. 12a;

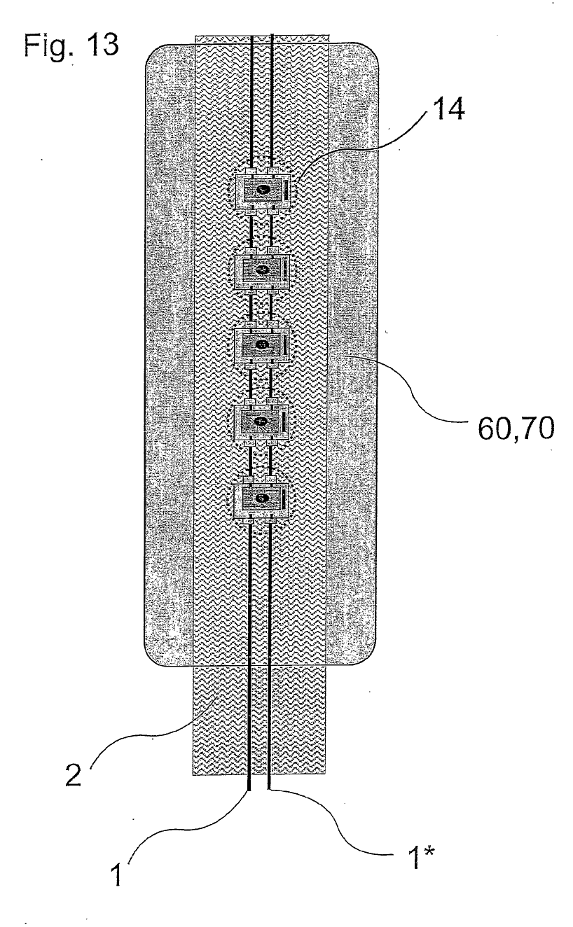

FIG. 13 is a top view of the device according to the eleventh embodiment but having a fabric cover system;

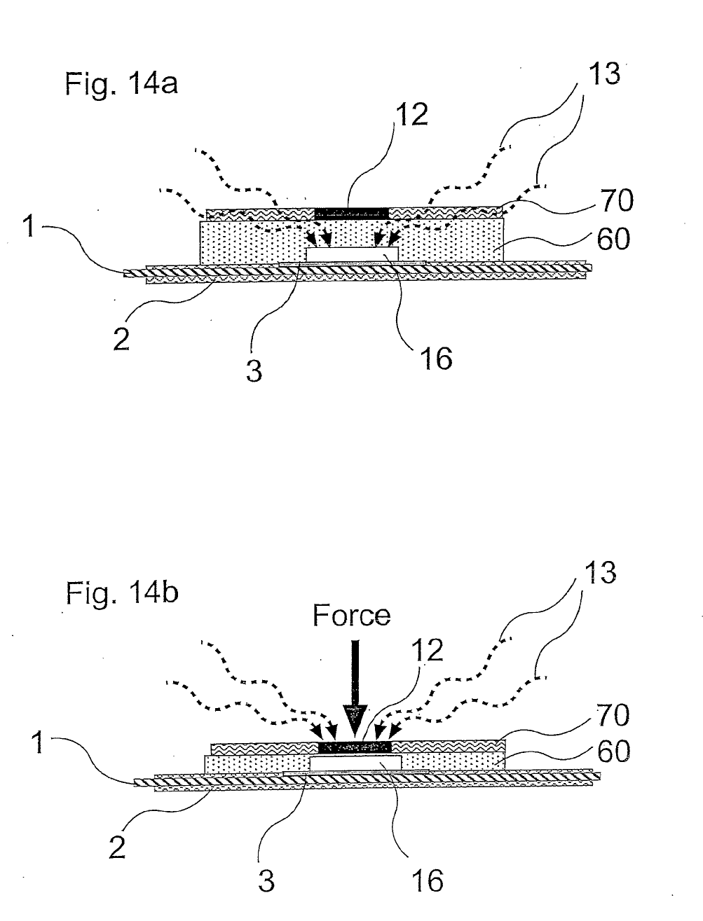

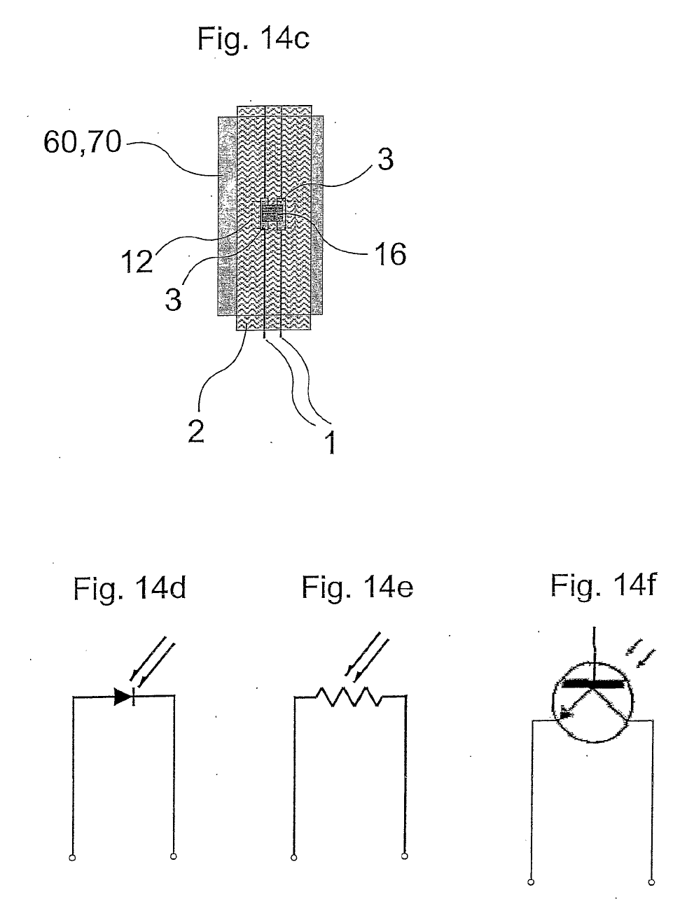

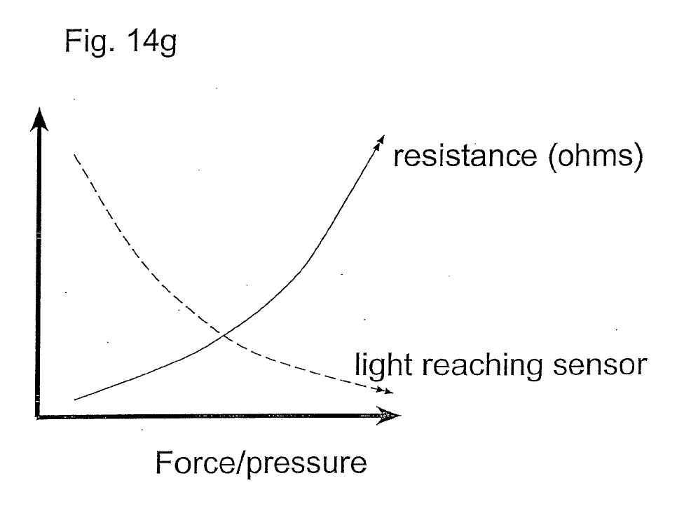

FIG. 14a is a side cross-section of a device according to a twelfth embodiment, wherein the device is in a first state;

FIG. 14b is a side cross-section of the device of FIG. 14a, wherein the device is configured in a different state;

FIG. 14c is a top view of the device of FIGS. 14a and 14b;

FIG. 14d is a circuit diagram of the device of FIG. 14a, wherein the contact maker is a photodiode;

FIG. 14e is a circuit diagram of the device of FIG. 14a, wherein the contact maker is a light dependent resistor;

FIG. 14f is a circuit diagram of the device of FIG. 14a, wherein the contact maker is a phototransistor;

FIG. 14g is a graph showing the relationship between force exerted on the device of FIG. 14a and electrical resistance between the electrodes.

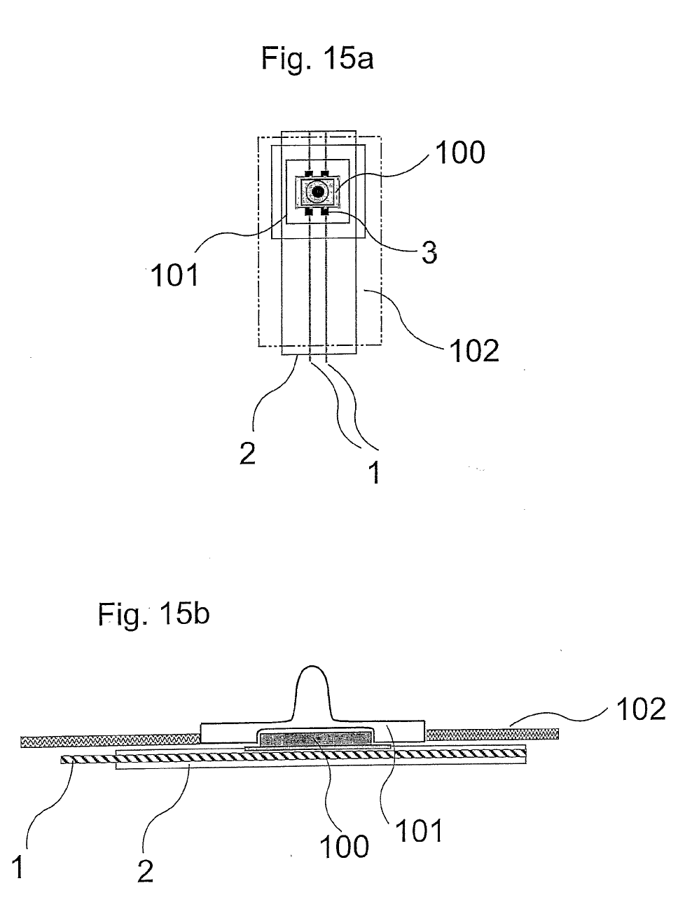

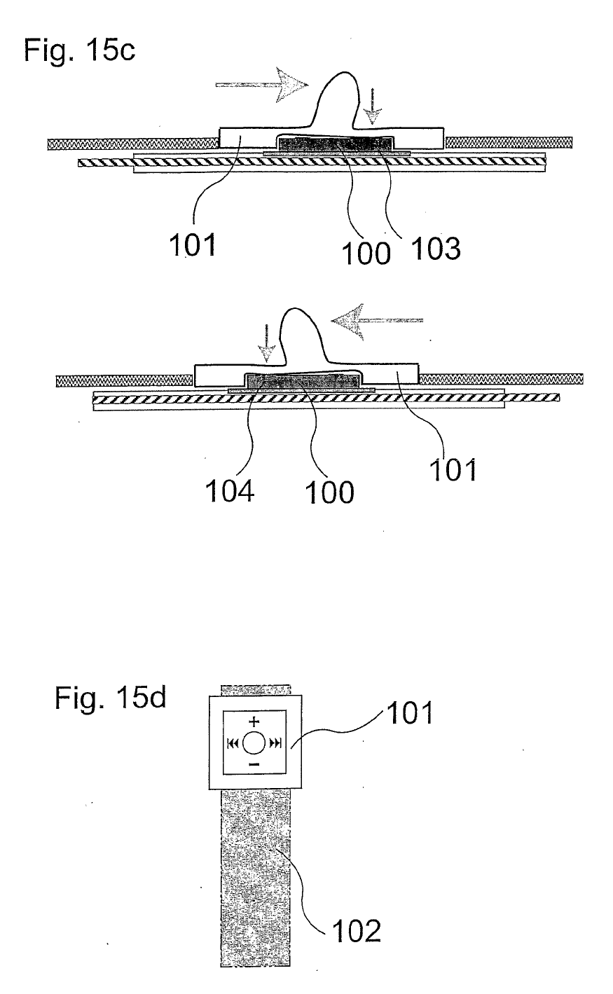

FIG. 15a is a schematic plan view of a device according to a further embodiment. FIG. 15b is a schematic sectional view of the device of FIG. 15a.

FIG. 15c shows further schematic sectional views of the device of FIG. 15a and 15b, in alternative configurations.

FIG. 15d is a top view of the device of FIGS. 15a-c.

Preferred embodiments of the present invention will now be described in detail with reference to the drawings. In each case the invention seeks, where possible, to create versatile textile-based devices in which continuous conductive threads are incorporated in the weave and are subsequently combined with one or more discrete elements to create devices. This approach allows a versatility not found in the previously considered textiles and permits, for example, the creation of “bespoke” devices with different functions, chosen after the initial weave, which utilize a previously manufactured common base material

FIG. la shows a side cross-section of a first embodiment of a switch. The conductor carrier of this switch comprises an electrode member 2 which has two electrodes (electrically conductive tracks) 1 as electrical conductors, the electrodes being embedded within the electrode member 2. The electrodes 1 are shielded within the electrode member 2, except at contact points 3 and 6 where they are exposed to the surface of the electrode member. The contact points 3 and 6 are on separate parallel electrodes, as shown in FIG. 1c. In this embodiment, the contact member 4 is a moulded film of electrically conductive rubber having an integral moulded dome shape or recess, recessed from the conductor carrier, 8 provided therein. This film is positioned on top of (adjacent to and facing) the electrode member and is permanently fixed to one of the electrodes of the electrode member at the contact point 6, with stitching, to provide a permanent electrical contact between the contact point 6 and the contact maker 4. In an open configuration (state) (hereinafter referred to as a second configuration or state) of the contact maker, as shown in FIG. 1a, there is no contact between the contact maker 4 and the contact point 3 of the other electrode.

FIG. 1b is also a side cross-section of the switch according to the first embodiment, but shows the contact maker of the switch in a closed configuration (state) (hereinafter referred to as a first configuration or state) when a force is applied to the contact maker in the region of the moulded dome 8, above the contact point 3. Thus, when a force is exerted on the dome 8 of the contact maker, the dome 8 is mechanically deformed such that it touches the contact point 3 and closes the electrical circuit between contact points 3 and 6 on the two electrodes. The contact maker is resiliently biased in at least one of the first and second configurations. The mechanical deformation may be elastic deformation. Furthermore, the dome provided in the contact maker helps to provide haptic and tactile feedback during circuit closure, so that the user knows when the switch has been activated.

FIG. 1c is a top view diagram of the switch shown in FIGS. 1a and 1b, looking through the contact maker 4. Here the two electrodes 1 can be seen, together with the exposed contact points 3 and 6, which are provided on separate electrodes at different positions along the electrode member 2.

In FIG. 1d, there is shown a circuit diagram representing the circuit formed between the electrodes 1 in the second state. In the first state, the switch becomes closed.

FIG. 2a shows a side cross-section view of a second embodiment of a switch. This switch also contains two electrodes 1, which are embedded within an electrode member 2. The electrodes 1 are shielded within the electrode member 2 except at contact points 3 where they become exposed. One contact point 3 is provided on each of the separate parallel electrodes, as shown in FIG. 2c. As in the first embodiment, the contact maker 4 is a moulded film of electrically conductive rubber having an integral moulded dome shape (recess). This film is positioned on top of and facing the electrode member 2.

However, unlike the first embodiment, in this switch the contact maker 4 does not have a permanent contact with either of the contact points 3. Hence, when the contact maker is in its second configuration, there is no contact between the contact maker 4 and the contact points 3.

FIG. 2b shows the same switch as is shown in FIG. 2a, also in cross-section. However, FIG. 2b shows the switch in a first configuration, i.e. when a force is exerted on the dome 8 of the contact maker 4. It can be seen that when sufficient force is applied to the dome 8 of the resiliently biased contact maker 4, the contact maker is configured in the first configuration such that it touches both of the contact points 3 and therefore closes the electrical circuit between them.

In FIG. 2c, there is shown a top view diagram of the switch of FIGS. 2a and 2b, looking through the contact maker 4. Here, it can be seen that the exposed contact points 3 are provided adjacent to one another along the parallel electrodes 1.

FIG. 2d is a circuit diagram representing the circuit formed between the electrodes 1 in the second configuration of the contact maker 4. In the first configuration, the switch becomes closed.

It should be noted that the switch of each of the first and second embodiments may have any number of contact makers 4, or domes 8 provided in a contact maker 4, together with a corresponding number of contact points 3 along the length of the electrodes 1, so as to act as a multiple switch having as many switches as are desired.

FIG. 3a shows a side cross-section of a switch according to a third embodiment, which is similar to the switch according to the first embodiment. In this switch, the surface of the contact maker 4 comprises of a moulded conductive rubber which is bonded to a flexible film or fabric 5. As can be seen, a dome or concave shape (recess) is moulded into the under-side of the contact maker 4 whilst the upper surface of the contact maker is flat. The flexible film or fabric 5 gives the switch the appearance of a flat fabric surface. Hence, the switch can be hidden within a textile article.

As in the first embodiment, the conductor carrier is an electrode member 2 having two exposed contact points 6, 3, provided for first and second electrodes, respectively, one of which 6 is permanently attached to the contact maker and the other of which only connects with the contact maker under mechanical deformation of the dome 8 of the contact maker. FIG. 3a shows the switch in the second, non-contacting, configuration of the resiliently biased contact maker.

FIG. 3b shows the same switch as in FIG. 3a, in cross-section, when a force is exerted on the fabric 5 above the recess 8 of the contact maker. This causes the recess 8 of the contact maker 4 to be mechanically, preferably elastically, deformed such that the contact maker touches the contact point 3 and closes the electrical circuit between the contact points 3 and 6. When this occurs, the contact maker is in the first configuration.

FIG. 4a is a side cross-section view of a switch according to a fourth embodiment. This switch is similar to that of the third embodiment, with the additional feature that the contact maker 4 is not only provided with a concave recess 8, but is also prevented, in the second configuration, from making contact with the contact point 3 by a series of non-conductive nodules (microdots) 9 that are provided on the underside of the contact maker 4 in the recess. Preferably, the non-conductive nodules 9 are moulded on the underside of the contact maker 4.

FIG. 4b shows the switch of FIG. 4a when a force is exerted on the fabric 5 above the recess 8 of the contact maker 4, wherein the nodules 9 are compressed and the conductive material of the contact maker touches the contact point 3 and closes the electrical circuit between the contact points 3 and 6. When this occurs, the contact maker is in the first configuration. As in the first and third embodiments, contact point 6 is permanently fixed to the contact maker 4.

FIG. 5a is a top view of a fifth embodiment of a switch. This switch is similar to those of the above described first, third and fourth embodiments, as a contact point 6 is provided on one of the electrodes which is permanently attached to the contact maker 4. However, a further five electrodes are provided on the electrode member 2, provided as a conductor carrier, each of which is provided with an exposed contact point 3. A dome or recess 8 is provided in the contact maker 4 above each of these contact points 3. Thus, this switch acts as a multiple switch operable to switch between five separate pairs of electrodes 1.

In this embodiment, as stated above, each electrode 1 corresponds to (is provided with) a separate contact point 3, with the exception that the contact maker 4 is permanently fixed to one electrode of the electrode member 2 at contact point 6. When a force is exerted on any one of the domes or recesses 8 of the contact maker, causing the contact maker to be mechanically deformed into its first configuration at that point, the contact maker 4 touches the corresponding contact point 3 and closes the electrical circuit between the corresponding contact point 3 and the fixed contact point 6. Thus, the switch is a five switch system.

The domes or recesses 8 may be formed according to the design of any of the first, third and fourth embodiments. A fabric 5 may be attached to the top of the switch by stitching 7 for example.

FIG. 5b is a circuit diagram represented by the switch shown in FIG. 5a. The five possible different switch connections can be seen clearly. Of course, it is possible to increase the number of switch connections beyond five by providing more electrodes with contact points 3.

FIG. 6a is a side cross-section of a switch according to a sixth embodiment. This switch is similar to that of the third embodiment, shown in FIGS. 3a and 3b, but enables switching to be performed between a first electrode and any one of three other electrodes. The contact member 4 is permanently fixed to the electrode member 2 at contact point 6 provided on the first electrode. Also, the electrode member 2 and the contact maker 4 are curved so as to form an uneven surface. Each of the other three electrodes has a contact point 3, and the contact maker is configurable to electrically connect any of these three electrodes to the first electrode.

FIG. 6b is a cross-section of the switch shown in FIG. 6a when a force is exerted on a layer 5 above the contact point 3 of the middle one of the three other electrodes. When sufficient force is exerted on the layer 5 at this point, the contact maker is mechanically deformed so that the contact maker 4 touches the contact point 3 of this electrode and closes the electrical circuit between the contact point 3 and the permanent contact point 6. When this occurs, the contact maker is in the first configuration. The uneven surface of the switch helps to ensure that the contact maker only makes electrical contact with the desired contact point, thus helping to eliminate accidental or unwanted switching. The whole switch of this embodiment may be encapsulated in a polymer material 5 to make it durable.

FIG. 7a is a side cross-section of a switch similar to that shown in FIGS. 4a and 4b but enabling switching to be performed between a first electrode and any one of three other electrodes. As in the sixth embodiment described above, the electrode member and the contact maker are curved so as to form an uneven surface.

The conductor plane 4 is permanently fixed to the electrode member 2 at contact point 6 provided on the first electrode. Each of the other three electrodes 1 has a separate contact point 3.

In this switch, in the second configuration, the contact maker 4 is prevented from making contact with the contact points 3 on each electrode by a series of non-conductive nodules 9 that are pre-formed on the underside of the contact maker 4, in addition to being provided with a series of concave recesses.

FIG. 7b shows a side cross-section of the same switch as in FIG. 7a when a force is exerted on the layer 5 above the middle one of the three electrodes. When sufficient force is exerted, the nodules 9 are compressed and the contact maker 4 touches the contact point 3 and closes the electrical circuit between the contact point 3 and the fixed contact point 6. The whole device is encapsulated in a polymer material 5 to make it durable.

FIG. 8a shows a device, in side cross-section, according to an eighth embodiment of the invention. In this device, a conductor carrier comprises an electrode member 2 having two electrodes 1 forming a fabric databus. A single contact maker is mounted on the electrode member and is embedded within a polymer foam 60 and fabric 70 system. The contact maker comprises an SMD type tact switch (push button switch) 50 fixed to a small PCB 40 which is mounted on the electrode member 1.

Each of the two electrodes 1 is embedded within the electrode member 2, such that it is shielded within the electrode member except at contact point 3 where it makes contact with a crimped fixture. The contact points 3 are on separate parallel electrodes (as shown in FIGS. 8b and 8c). The SMD tact switch 50 is soldered to the small PCB 40. The PCB 40 is in turn soldered onto the crimp fixtures 3. The electrode member 2 and the contact maker 40, 50 are covered in a soft foam polymer 60 which is bonded to fabric 70.

When a force is exerted on the area of the fabric 70 located directly above the SMD tact switch 50, the fabric 70 and foam 60 are compressed, which in turn applies pressure to the SMD tact switch 50 thus closing the circuit (shown in FIG. 8d). The device can be bended or folded in a small radius.

FIG. 8b is a top view diagram of the switch shown in FIG. 8a. Here the two electrodes 1 can be seen within the fabric of the electrode member structure. The foam material 60 and the top fabric 70 are positioned on top of the electrode member 2 but are shown here as transparent to reveal other features of the device.

FIG. 8c is a top view diagram of a device similar to that shown in FIGS. 8a and 8b, but wherein the contact maker comprises only the SMD tact switch 50 which is attached directly onto the contact points 3 using solder. In other words, no PCB 40 is provided.

FIG. 8d is a circuit diagram representing the circuit formed by the device of FIGS. 8a and 8b, and FIG. 8c.

FIG. 9a is a side cross-section view of a device according to a ninth embodiment. This device also contains an SMD type tact switch as a contact maker, but differs slightly from that of the eighth embodiment. As in the eighth embodiment, the electrodes 1 are shielded within the electrode member 2, acting as a conductor carrier, but make contact with crimped fixtures at contact points 3. The contact points 3 are on separate parallel electrodes, as shown in FIG. 9b. A foam rubber material 60 containing a hollow void (recess) 14 is positioned over the SMD tact switch 50 so as to create a void over the tact switch. A fabric 70 is bonded to the foam rubber 60 to give the surface of the device a desired aesthetic appearance. Having the hollow void 14 positioned over the contact maker allows the surface fabric 70 to appear flat and allows the contact maker (SMD tact switch) to be hidden within the structure.

When a force is exerted on the area of the fabric 70 located directly above the SMD tact switch 50, the SMD tact switch 50 closes the circuit (shown in FIG. 9d). In this example a disc 80 is placed over the tact switch to give a larger switching activation area on the fabric 70 surface. This disc 80 may be a flexible plastic insert or a membrane switch disc.

FIG. 9b is a top view diagram of the device shown in FIG. 9a. Here the two electrodes 1 can be seen within the fabric electrode member structure. The foam material 60 and the top fabric 70 are positioned on top of the electrode member 2 but are shown here as transparent to reveal other features of the device structure. A dotted line 14 indicates the hollow void in the foam material under the surface of the fabric 70.

The device of the eighth and ninth embodiments may have any number of contact makers along a given length of electrode member 2.

FIG. 10a shows a top view of a device according to a tenth embodiment. This device is similar to those of the eighth and ninth embodiments but has five SMT tact switch assemblies 11, i.e. contact makers, on a single electrode member 2. The SMD switch assembly 11, (shown more clearly in FIG. 10b) is the same for all five switch assemblies, wherein an SMD tact switch 50 is attached to a small PCB 40. The PCB 40 is then soldered onto different sets of contact points 3 which in this example are metal fixtures crimped onto the soft electrode member 2. The sets of contact point fixtures 3 are fixed onto different electrodes 1, 1 [symbol] along the length of the electrode member 2 and provide contact from each PCB 40 to two of the electrodes 1, 1 [symbol] such that each switch assembly (contact maker) 11 is making contact with two different electrode tracks 1, 1 [symbol] . Electrode 1 [symbol] is a ground electrode and the other electrodes 1 are signal electrodes. Therefore, when sufficient force is exerted above one of the switch assembles, a circuit is closed between the electrode 1 [symbol] and one of the other electrodes 1, as each switch assembly is configured to provide an electrical connection when sufficient force is exerted on it. Hence, the device enables switching to be performed between five pairs of electrodes.

The switch assemblies 11 may be attached and placed on the contact points 3 by hand or using ‘pick and place’ machinery.

In FIG. 10b, there is shown an expanded diagram of a switch assembly 11 shown in FIG. 10a. As stated above, in the switch assembly 11, the SMD type switch 50 is soldered onto a small PCB 40. The PCB 40 has four sets of solder points 90, 90 [symbol] . The solder point 90 [symbol] is the electrical ground of the switch and the three solder points 90 are connected together forming one common side of the switch. Usually, in each switch assembly, one of the solder points 90 is attached to a contact point 3. When the switch is pressed the circuit is closed between points 90 and 90 [symbol] . These solder points are spaced so as to align with the contact points 3 on the electrode member 2.

FIG. 10c is a circuit diagram of the switch assembly shown in FIG. 10b, when all of the solder points 90 are connected to electrodes by means of contact points 3.

FIG. 10d is a circuit diagram of the switch system shown in FIG. 10a.

FIG. 11 shows the switch of the tenth embodiment but having a fabric cover system. A combined foam rubber and textile fabric layer 60, 70 is stitched onto the electrode member 2, so as to encapsulate each of the contact makers. Moulded hollow voids are provided as in the ninth embodiment and are represented by the dotted line circles 14.

When the area of fabric above a contact means is pressed, a circuit is closed between the electrode 1* and the corresponding electrode 1. In this figure, the device forms a flexible system containing five hidden switch assemblies 11.

FIG. 12a is a top view of a device according to an eleventh embodiment. In this device, there are five separate contact makers (switch assemblies) 15 attached to two electrodes 1, 1 [symbol] . The electrodes 1, 1 [symbol] are shielded within the electrode member 2 but make contact with crimped fixtures at contact points 3. The contact points 3 are fixed to each of the separate parallel electrodes 1, 1 [symbol] . Each switch assembly 15 is attached to a set of contact points 3 on each electrode of the electrode member 2. When force is exerted on any of the switch assemblies 15 of the device the circuit between the electrodes 1 and 1 [symbol] is closed.

A resistor is placed in series on the PCB of each of the switch assemblies, as shown in FIG. 12b, to enable individual switch assemblies to be differentiated. They can be differentiated by measuring the total resistance of the closed circuit. Thus, for a given switch assembly the total resistance is equal to the sum of the resistors below that switch assembly, as shown in the circuit diagram of FIG. 12d. For example, if the lower switch assembly is pressed the circuit resistance between electrodes 1 and 1 [symbol] will be R4. If the next switch up is pressed the circuit resistance will be R3+R4 and so on. A PIC microprocessor can be provided at the ends of the two electrodes in the circuit, as shown in FIG. 12d, and is able to monitor the resistance of the circuit and therefore differentiate between the five switch assemblies. Hence, a device having five separate switch connections is created.

The switch assemblies 15 may be attached and placed on the contact points 3 by hand or using ‘pick and place’ machinery.

FIG. 12b is an expanded diagram of a single switch assembly 15 shown in FIG. 12a. The SMD type switch 5 is soldered onto a small PCB 4 which has two sets of solder points 90. When the switch is pressed the circuit is closed between the solder points 90. These solder points are spaced so as to align with the contact points 3 on the electrode member 2. A resistor 10 is also placed in series with the switch on the PCB.

FIG. 12c is a circuit diagram of the switch assembly shown in FIG. 12b and FIG. 12d is a circuit diagram of the switch shown in FIG. 12a.

FIG. 13 is a top view of the device shown in FIG. 12a but having a fabric cover system similar to that shown in FIG. 9a. A combined foam rubber and textile fabric layer 60, 70 is bonded onto the electrode member 2 so as to encapsulate each of the switch assemblies (contact makers). The moulded hollow voids are represented by the dotted line circles 14.

When the area of fabric above one of the switch assemblies is pressed, a circuit is closed between the electrodes 1 and 1 [symbol] , with the addition of a resistor for each switch along the electrode (as described in FIG. 12a). Thus, this figure shows a device providing a flexible system with five independent switch assemblies.

FIG. 14a is a side cross-section view of a device according to a twelfth embodiment. This device comprises a light sensitive electronic component as a contact maker, the light sensitive electronic component being embedded within a polymer foam and fabric system. The device has a conductor carrier comprising an electrode member with two electrodes as a fabric databus, the electrodes being attached to the light sensitive component. In this figure, the light sensitive component is an SMD type photodiode. The two electrodes 1 are embedded within the electrode member 2, with each electrode 1 being shielded within the electrode member 2 but for contact with a crimped fixture at a contact point 3. Thus, each of the separate parallel electrodes has a contact point 3, as shown in FIG. 14c. The photodiode 16 is soldered to the contact point fixtures 3. The electrode member and the photodiode are covered in a soft foam polymer 6 which is bonded to a fabric cover 70. In a first state, light 13 is able to penetrate through the fabric cover 70 to reach the photodiode 16 except where a printed area 12 prevents light transmission.

As shown in FIG. 14b, when a force is exerted on the fabric cover 70 above the printed area 12, the material 60 is compressed and the printed area 12 prevents light reaching the photodiode 16. Hence, the device shown in FIGS. 14a and 14b acts as a force activated switch or sensor. The light sensitive component (photodiode) 16 changes resistance depending on the amount of light it receives. When the device is in the state shown in FIG. 14a, light is able to reach the photodiode 16 through the material 60 therefore the circuit between the electrodes 1 is closed. As the printed area 12 is pressed, however, the light is increasingly blocked out and the resistance of the circuit increases in proportion to the amount of light blocked out. This can be seen from the circuit diagram of FIG. 14d and by the graph of FIG. 14g. Thus, this device can be used as a switch or as a proportional response sensor.

FIG. 14c is a top view diagram of the switch shown in FIGS. 14a and 14b. Here the two electrodes 1 can be seen within the fabric electrode member structure with contact point fixtures 3 attached to the electrode member 2. The foam material 60 and the cover fabric 70 are positioned on top of the electrode member 2 but are shown here as transparent to reveal other features of the structure. A dotted area 12 shows the position of the printed area described in FIGS. 14a and 14b.

FIGS. 14d, 14e and 14f show circuit diagrams of the device of the twelfth embodiment when the light sensitive component is a photodiode, light dependant resistor and phototransistor, respectively. FIG. 14g is a graph representing the general relationship between force on the device of the twelfth embodiment and electrical resistance between the two electrodes 1.

FIGS. 15a-15d show an alternative embodiment of device according to the invention.

In this embodiment a multi-function switch component is attached to the electrode member. The multi-function switch component is a single component unit with typically more than one micro switch contained internally. In this example the multi-function switch component has five switches (for example Citizen Lumiswitch type LS25) and shall be referred to as a ‘multi-switch’. The multi-switch is attached to the electrode member by soldering or conductive adhesive to contact points, which may be metal fixtures, described in previous examples. The multi-switch may be fixed to a small PCB prior .to attachment to the electrode member. The multi-switch component may be any surface mount or thru-hole mount type switch component containing one or more switches.

A suitable rubber component is fixed above the multi-switch creating a joystick function. The rubber component or joystick when moved in a certain direction actuates a single switch within the multi-switch by pushing down onto a certain region of the multi-switch. In the example below pushing the rubber joystick component forward actuates the first switch, backward the second, left the third, right the fourth etc.

The soft rubber joystick component may be attached to the electrode member by sewing or using an adhesive. The soft rubber joystick component may be moulded from silicone, PU, PVC, EVA or any other soft material.

The embodiment creates a textile based joystick system with a soft rubber interface suitable for a controller used in wearable electronics or other electronic textile applications. This give a very user-friendly and highly responsive soft interface system where many switch functions may be operated from a single soft component.

FIG. 15a shows a top schematic, or transparent view of an example of the embodiment. The electrode member 2 containing the electrodes 1 has metal fixtures 3 permanently attached to it. The multi-switch component 100 is attached to the metal fixtures 3 by solder. The rubber joystick component 101 is fixed to the electrode member 2 and cover fabric 102 by sewing and is located directly above the multi-switch component 100.

FIG. 15b is a side view of the same device shown in 15a. Here is can be seen that the rubber joystick component 101 has a recess on the underside of the component to help locate its position on the multi-switch component 100. It can see also that the rubber joystick provide impact and abrasion protection for the multi-switch component.

FIG. 15c shows an example of the overall device mechanism. It can be see that when the rubber joystick component 101 is pushed in a forward direction the force causes the rubber to press onto a single switch area 103 on the multi-switch 100 activating the switch 103. When the rubber joystick component is pushed in the reverse direction the rubber presses on a different single switch area 104 on the multi-switch 100 component activating the single switch 104. In this manner, moving the joystick rubber component in different directions can activate different switches on the multi-switch component.

FIG. 15d shows a drawing of finished device system of a five-switch joystick. Single switches are individually activated by pushing the rubber joystick left, right upwards, downwards and straight down.

In any of the above described embodiments, visual feedback may be provided to a user by means of one or more LEDs attached to the switch or device. For example, each switch assembly in a device within a textile article could be associated with a distinct LED provided on or immediately underneath the outer layer (surface) of the article. Each LED could have a different colour.

What is claimed is:

1. A switch for use in a soft article, such as a textile article, comprising:
a conductor carrier having a plurality of electrical conductors; and
a flexible contact maker comprising an electrically conductive substrate, the flexible contact maker being disposed adjacent to the conductor carrier; wherein the contact maker is configurable in either a first configuration in which it electrically connects two of the electrical conductors or a second configuration in which it does not electrically connect two of the electrical conductors, the contact maker being resiliently biased in at least one of the first and second configurations.

2. A switch according to claim 1, wherein the contact maker forms part of a contact layer.

3. A switch according to claim 1, wherein the electrical conductors are electrically shielded from the contact maker except at exposed contact points.

4. A switch according to claim 3, wherein the contact maker is permanently connected to one of the electrical conductors at a contact point on that electrical conductor.

5. A switch according to claim 4, wherein the contact maker electrically connects to a contact point on another of the electrical conductors when the contact maker is in the first configuration.

6. A switch according to claim 3, wherein each of the electrical conductors has a contact point and the contact maker electrically connects to two of the contact points, each on a separate electrical conductor, in the first configuration.

7. A switch according to claim 1, wherein the electrically conductive substrate of the contact maker is an electrically conductive rubber.

8. A switch according to claim 1, wherein the contact maker has at least one concave recess.

9. A switch according to claim 8, wherein the at least one concave recess is mechanically deformable so as to cause the contact maker to be either in its first configuration or in its second configuration.

10. A switch according to claim 8, wherein a series of non-conductive nodules are formed on each concave-recess.

11. A switch according to claim 1, wherein the outer surface of the contact maker is bonded or stitched to a flexible film or fabric.

12. A switch according to claim 1, wherein the conductor carrier and the flexible contact maker conform to an uneven surface.

13. A switch according to claim 1, wherein the conductor carrier and the flexible contact maker are encapsulated in a polymer material.

14. A switch according to claim 1, further comprising at least one LED to provide visual feedback to a user.

15. A device for use in a soft article, such as a textile article, comprising:
a conductor carrier having a plurality of electrical conductors;
at least one contact maker mounted on the conductor carrier and physically attached to two of the electrical conductors; and
an outer layer covering the conductor carrier and the at least one contact maker; wherein each contact maker is configurable to provide an electrical connection between the two electrical conductors to which it is physically attached, the electrical connection depending on a force exerted on the outer layer above the contact maker.

16. A device according to claim 15, wherein the electrical conductors are electrically shielded from the at least one contact maker except at exposed contact points at which they are attached to the at least one contact maker.

17. A device according to claim 15, wherein each contact maker is configurable in either a first configuration in which it electrically connects two of the electrical conductors or a second configuration in which it does not electrically connect two of the electrical conductors, the contact maker being resiliently biased in at least one of the first and second configurations.

18. A device according to claim 17, wherein each contact maker comprises an SMD tact switch.

19. A device according to claim 17, wherein each contact maker comprises an SOD tact switch mounted on a PCB.

20. A device according to claim 19, wherein a resistor is mounted on the PCB of each contact maker.

21. A device according to claim 15, wherein the outer layer has a hollow recess surrounding the contact maker.

22. A device according to claim 15, wherein the contact maker is a light sensitive component.

23. A device according to claim 22, wherein the outer layer has an opaque region above the light sensitive component.

24. A device according to claim 23, wherein when a force is exerted on the outer layer the amount of light reaching the light sensitive component decreases.

25. A device according to claim 24, wherein the resistance of the electrical connection between the two electrical conductors varies in dependence on the amount of light reaching the light sensitive component.

26. A device according to claim 25, wherein the resistance increases as the amount of light reaching the light sensitive component decreases.

27. A device according to claim 15, wherein the outer layer comprises an outer fabric layer and an inner polymer layer.

28. A device according to 15, wherein the device further comprises at least one LED for providing visual feedback to a user.

29. (canceled)

30. (canceled)
